(19) United States
(12) Patent Application Publication
(10) Pub. No.: US 2018/0284086 A1
(43) Pub. Date: Oct. 4, 2018

(54) SYSTEM AND METHOD FOR VISUALIZING CHEMICAL REACTIONS IN REAL TIME

(71) Applicants: Mathew Maye, Binghamton, NY (US); Tennyson Doane, Quincy, MA (US)

(72) Inventors: Mathew Maye, Binghamton, NY (US); Tennyson Doane, Quincy, MA (US)

(73) Assignee: Syracuse University, Syracuse, NY (US)

(21) Appl. No.: 15/756,657

(22) PCT Filed: Aug. 30, 2016
(86) PCT No.: PCT/US16/49395

§ 371 Date: Mar. 1, 2018

Related U.S. Application Data
(60) Provisional application No. 62/213,381, filed on Sep. 2, 2015.

(51) Int. Cl. G01N 31/22; G01N 21/64

(52) U.S. Cl. CPC G01N 31/22; G01N 21/64

(57) ABSTRACT

A nanoparticle based assay for monitoring chemical reactions in real-time, ion concentrations in solution, and oxidation potential of ions in solution is describe. The assay is based on use of photoluminescent perovskite nanoparticles with the composition XYZ₃. The XYZ₃ nanoparticles are added to a reaction or a solution to be analyzed, and the optoelectronic response of the nanoparticle is proportional to the chemical kinetics of the reaction or concentration of target. The resulting color changes can be qualitatively monitored by eye or quantitatively by spectroscopy. The assays may serve as a compliment or replacement for routine chemical analysis performed over the course of a reaction.

### BACKGROUND OF THE INVENTION

### 1. Field of the Invention

The present invention relates to a chemical reaction visualization system and, more specifically, to a nanoparticle based system for participating in, visualizing, and quantifying reactions in real time.

### 2. Description of the Related Art

Monitoring a multi-step organic reaction is a challenge and typically requires the use of nuclear magnetic resonance (NMR), mass spectroscopy (MS), high performance liquid chromatography (HPLC) or thin-layer chromatography (TLC) based assays. This is achieved by periodically sampling a reaction medium and transport of it for one of these analyses. The reaction in question often utilizes organohalides, whose many forms are the basis for elimination and conjugation reactions, and are used in many multi-step syntheses of new molecules, drugs, or polymers. During these reactions, elimination of the halogen leads to the generation of halide anions the concentration of which is proportional to the reaction kinetics, yields, and pathways. If it were possible to easily monitor such concentration gradients in solution, it would lead to a simple bench top probe, allowing a researcher to monitor a large array of reactions by eye.

One underexplored application for the optoelectronic properties of nanoparticles is to use colorimetric changes to directly monitor chemical reactions, or to use the nanoparticles as reactants or catalysts in synthetic organic chemistry. For example, many different classes of nanoparticles, ranging from quantum dots to noble metals, have tunable optical properties; however such tunability often occurs only at the point of synthesis, and exposure to varied environmental conditions lead to only minimal changes, such as photoluminescence quenching or plasmon shifts. It would therefore be very useful for the broader synthesis community, the chemical, petrochemical, and pharmaceutical industry, as well as the analytical chemistry and sensor community to use NP reactivity to monitor organic reactions. Considering the expense of sampling and characterization of a reaction as a function of time, temperature, concentration, etc. a bench top probe that uses a miniscule amount of assay could visually demonstrates the extent or rate of reaction occurring would be transformational.

### BRIEF SUMMARY OF THE INVENTION

The present invention comprises the use of nanoparticle system that changes its optoelectronic response during chemical reactions, either by participating in the reaction (i.e. reactant or catalyst), or reacting with by-products or products of the reactants. This optoelectronic response is a color change both in visible and Ultra-violet absorption, but also in photoluminescence. The present invention comprises the use of nanoparticles that have a perovskite or perovskite-like crystallographic lattice (denoted herein as NPs and P-NPs) of the general composition XYZ₃, where X is a monovalent positively charged ion or molecule, Y is a positively charged divalent ion or molecule, and Z is a monovalent negatively charged ion or molecule. The nanoparticles of the present invention serve as colorimetric probes of ions in solution, as halide reservoir catalysts for exchange reactions, as well as probes to monitor chemical reactions in-situ. The present invention was tested using XYZ₃ NPs (5-30 nanometer diameters, X=Cs+, Y=Pb2+, F−, Cl−, Br−, I−), and it is envisaged that slight alterations to these compositions and morphologies will allow for further tuning of the properties described herein.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIGS. 1A and 1B are (a) a schematic of XYZ₃ conversion with TOAZ salts used and (b) the corresponding Goldschmidt tolerance factors as a function of effective ionic radius. In this demonstration, X=Cs⁺², Y=Pb⁺², and Z=F⁻, CH₃COO⁻, Cl⁻, NO₃_{^{−}}, Br⁻, I⁻, BF₄_{^{−}}, and Clo₄_{^{−}};

FIG. 2A through 2D are (a) Optical images and (b) UV-Vis/PL spectra of the CsPbX₃ used in this study, with different Br/I composition. (c) TEM micrograph of CsPbBr_{1.5}I_{1.5} and corresponding (d) PL decay results;

FIG. 3A through 3C are (a) Optical images of CsPbBr₃ before (i) and after (ii) dropwise addition of tetraoctylammonium iodide (TOAI) dissolved in 1-butanol. Mixing the solution (iii) results in a uniform PL emission, but subsequent addition of twice the amount of tetraoctylammonium bromide (TOABr) results in the reverse gradient (iv). Representative absorbance (b) and PL (c) spectra are shown;

FIG. 4A through 4D are a comparison of spectral properties of CsPbI₃ converted in 50-50 hexane/l-butanol (a and b) and in pure hexanes (c and d) at different Br concentrations. Lower concentrations of Br result in lowered PL of the final product relative to bulk additions, and the overall quantum yield is improved in a 50-50 mixture of butanol and hexanes;

FIG. 5A through 5C detail the changes in (a) absorbance and (b) photoluminescence of CsPbI₃ NPs upon treatment with different alkylammonium salts. (c) Titrations of NPs with different amounts of nitrate and perchlorate oxidants (0-29 mM) lead to halide dependent color changes, corresponding to the electrochemical oxidation potential of the ions in organic media;

FIGS. 6A and 6B are (a) Absorbance spectra of sequential additions of tetraoctylammonium chloride and tetrabutylammonium fluoride to CsPbBr_{1.5}I_{1.5} NPs. (b) Asorbance spectra of CsPbCl₃ and CsPbBr₃ NPs initially (black), after the addition of 10 μL of 10 mM tetrabutylammonium fluoride (red), and finally after the addition of 10 μL of 0.1M tetraoctylammonium chloride;

FIG. 7A through 7C are (a) Finkelstein reaction of 2-bromolauric acid to 2-iodododecanoic acid as monitored by photoluminescence of XYZ₃ (X=Cs, Y=Pb, Z=I). Inset shows PL shift after 75 minutes of reaction as a function of 2-bromododecanoic concentration. (b) First colorimetric assay of a chemical reaction using XYZ₃ nanoparticles. (c) Real time imaging of the Finkelstein reaction between NPs and 2-bromododecanoic acid versus the control reaction between NPs and 2-dodecanoic acid;

FIGS. 8A and 8B are a comparison of the CsPbI₃ PL spectra in the presence of excess amine (a) and (b) bromolauric acid as a function of time. Note that while doubling the amine does not dramatically affect the PL shift rate, doubling the bromolauric acid results in photoluminescence decay with only minor PL wavelength shift;

FIG. 9A through 9D are a comparison of the CsPbI₃ PL spectra in the presence of (a) 120 (b) 241 (c) 481 μM and (d) 962 μM 2-bromododecanoic acid with sufficient octylamine to undergo the reaction as a function of time. The spectra shift from right to left with time corresponding with generation of Br⁻ in solution;

FIG. 10 shows the rate of PL shift of XYZ₃ NPs during the reaction of 481 μM octylamine with an equal amount of 2-bromo-2-methylpropane (blue), 1-bromododecane (red), and 2-bromododecanoic acid (green);

FIGS. 11A and 11B are spectra (a) and normalized intensity plots (b) of CsPbI₃ PL as a function of temperature. The particles were found to be robust even at moderately high temperatures for a period of ˜46 min, at which point the PL decreases;

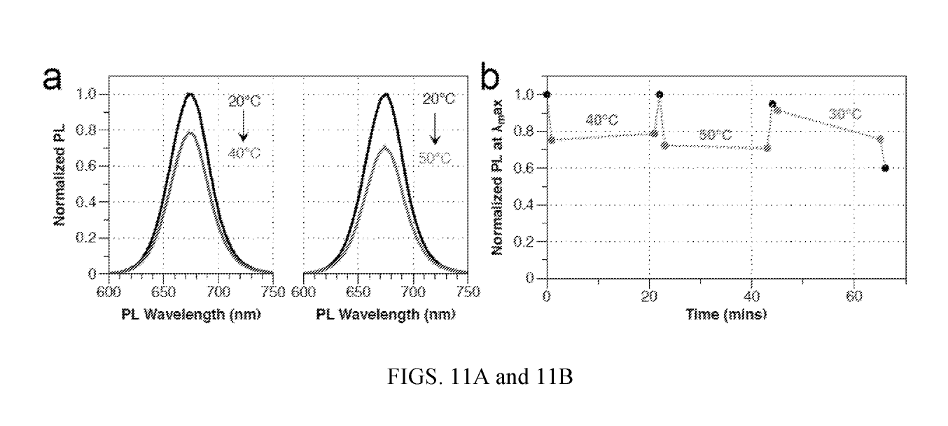

FIG. 12 is a schematic of using NPs either as direct reactants as ion reservoirs (a) or as colorimetric assays (b) of ion concentrations for determining chemical concentrations and reaction rates in real time;

FIGS. 13A and 13B show the resulting wavelength shifts of NP emission resulting from calibration against a known ion concentration (a) and during assaying of the reaction (b) of 32 mM 2-bromododecanoic acid with 4 mM octylamine in toluene under reflux;

FIG. 14A through 14C are the PL traces for combinatorial reaction monitoring of the Finkelstein reaction between (a) 2-bromododecanoic acid, (b) 1-bromododecane, and (c) 2-bromo-2-methylpropane and the CsPbI₃ NP in the presence of different amines (octylamine, trioctylamine, dodecylamine, hexadecylamine, pyridine, dimethylamino pyridine, and 1,4-diphenylamino pyridine are i-vii, respectively) as a function of time. Last column (vii) is the reaction of the NP with the organohalide alone;

FIG. 15 is the representative powder XRD of CsPbBr₃ showing cubic crystallinty, which is important for photoluminescence behavior;

FIG. 16 is the calibrated colorimetric response of CsPbI₃ NPs to free ion concentration as a function of NP concentration (32-108 μg/mL). Inset shows the optical image of the corresponding photoluminescence assay changes as viewed at the bench;

FIG. 17 is a image of the effect of ion concentration on CsPbCl₃ and CsPbI₃ NPs shown with corresponding emission spectra, revealing different ion sensitivity based on NP composition with CsPbI₃ being the more sensitive XYZ₃ composition;

FIG. 18 UV-Vis spectra of the sequential addition of CsPbI₃ NPs (red) with TOACl (purple), followed by TOAI (blue), and finally with TOABr (green), illustrating that transition of CsPbI₃ to CsPbCl₃ proceeds only in one direction, but can be reconverted to a mixture of CsPbBrₓCl_{y};

FIG. 19 is an image illustrating how conversion of raw CsPbI₃ NPs to a mixed CsPbBrₓI₃, NP with yellow emission, but dilution with ethyl acetate (εᵣ˜6.02) or 1-butanol (εᵣ˜17.51) leads to CsPbBr₃ or CsPbI₃ respectively due to changes to alklyammonium halide solubility products;

FIG. 20 is an image of the response of CsPbBr₃ NPs to increasing ion concentrations and polar solvents in the presence of methyphosphoinc acid (MPA), hexylphosphonic acid (HPA) octylphosphoinc acid (OPA) and a 50/50 mixture of MPA/HPA, where methylphosphonic acid shows the greatest photostability, even in the presence of more polar solvation environment;

FIGS. 21A and 21B shows the photoluminescence response of CsPbBr₃ NPs to ions in the presence of (a) phosphonic acid derived ligands (MPA, HPA, and OPA are methylphosphonic acid, hexylphosphonic acid, and octylphosphonic acid, respectively) and (b) thiol based ligands (DDT and OCT are dodecylthiol and octylthiol, respectively) relative to the native ligands obtained in synthesis shown as the control. CsPbBr₃ NPs are quenched in the presence of thiols but regain photoluminescence after ion exchange to CsPbI₃.

FIGS. 22A and 22B shows the photoluminescence response of CsPbI₃ NPs to ions in the presence of (a) phosphonic acid derived ligands (MPA, HPA, and OPA are methylphosphonic acid, hexylphosphonic acid, and octylphosphonic acid, respectively) and (b) thiol based ligands (DDT and OCT are dodecylthiol and octylthiol, respectively) relative to the native ligands obtained in synthesis. CsPbI₃ NPs are quenched in the presence of phosphonic acids but regain photoluminescence after conversion to CsPbBr₃; and

FIG. 23 shows the observed color change of NP loaded test strips (i) after being dipped into a solution of 0.1 M tetraoctylammonium bromide and (ii) as prepared under UV irradiation.

### DETAILED DESCRIPTION OF THE INVENTION

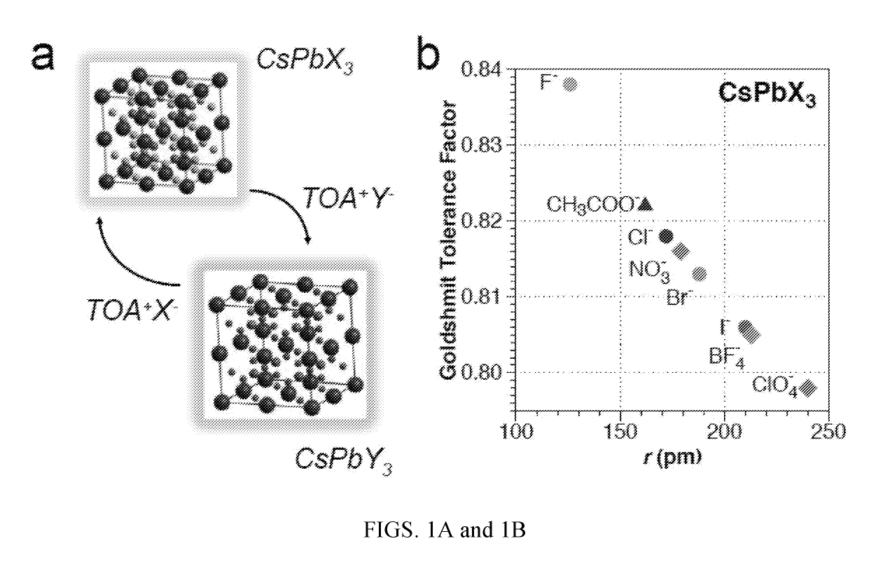

Referring now to the drawings, wherein like reference numerals refer to like parts throughout, there is seen in FIGS. 1A and 1B perovskite NPs of general composition XYZ₃ according to the present invention, where X is a monovalent cation, Y is a divalent cation, and Z is an anion. The present invention was tested using CsPbZ₃ NPs (5-30 nanometer diameters) in the presence of alkylammonium halide compounds.

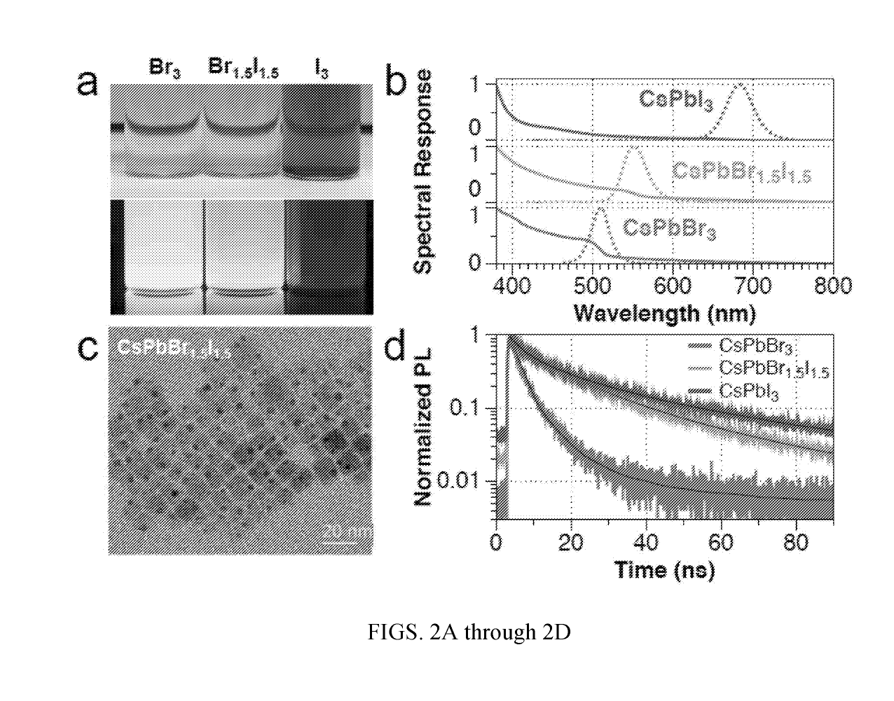

First, CsPbZ₃ NPs are synthesized according to a known method, where varying Br⁻ and I⁻ concentrations during synthesis yielded optically distinct materials. FIG. 2 shows the optical and morphological properties of the starting NPs, which were highly emissive (QY≈42-44%) with an increasing red shift as a function of [I⁻]. FIG. 2c shows the TEM of the 1:1 Br⁻/I⁻ reaction ratio. Interestingly, increasing I⁻ concentration was also found to correspond to increasing PL lifetime.

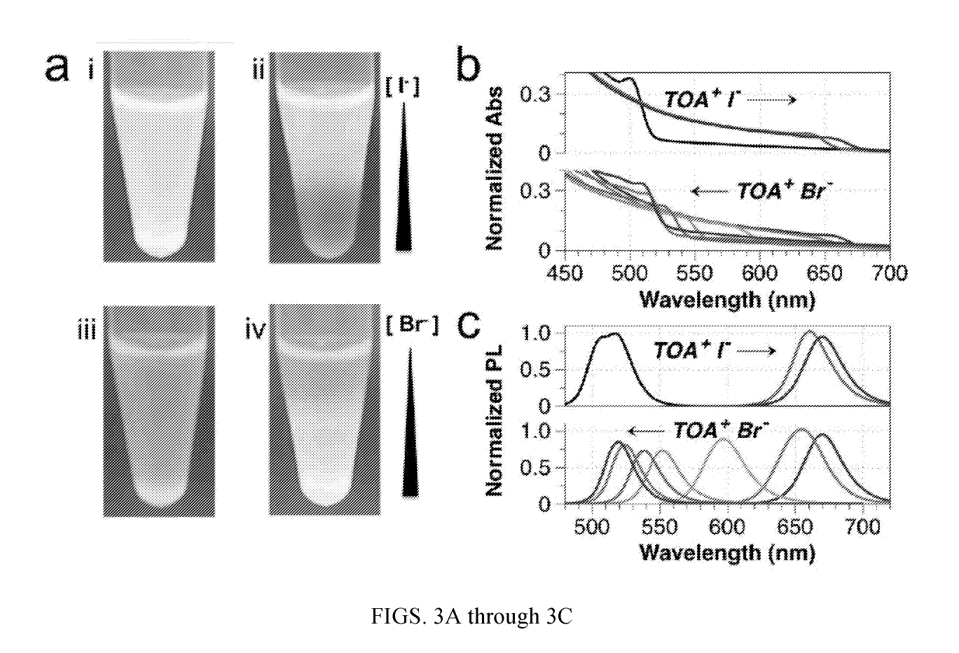

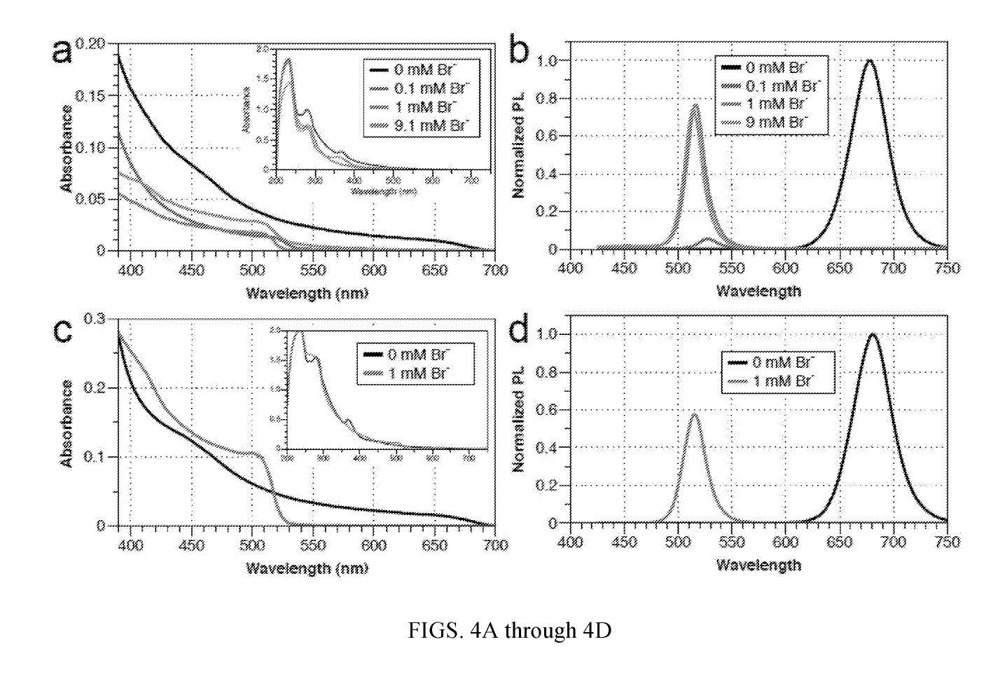

Next, exchange occurred at the CsPbZ₃ by addition of TOA⁺ Z⁻ salts dissolved in 1-butanol. FIG. 3 shows the transformation of CsPbBr₃ to CsPbI₃ and subsequently back to CsPbBr₃ upon the addition of TOA⁺ I⁻/Br⁻, in which the starting CsPbI₃ fluoresces a bright red color, whereas the CsPbBr₃ fluoresces a bright orange or blue depending on the extent of reaction. The images show the importance of local halide concentration, as adding TOA+I⁻ drop-wise results in a chemical gradient leading to the observed diverse color (i to ii) with pronounced redshift; mixing the solution (ii to iii) results in a uniform PL emission (iii). Similarly, adding twice the amount of TOA⁺ Br⁻ drop-wise results in the reverse gradient (iii to iv). This reversibility was monitored via UV-vis (FIG. 3b) and PL (FIG. 3c) spectra that showed this process was indeed incremental. Notably, the overall PL decreases when transitioning from CsPbI₃ to CsPbBr₃ but not in the reverse order. This loss could be improved by using a solution of 50/50 hexanes/l-butanol, as seen in FIG. 4.

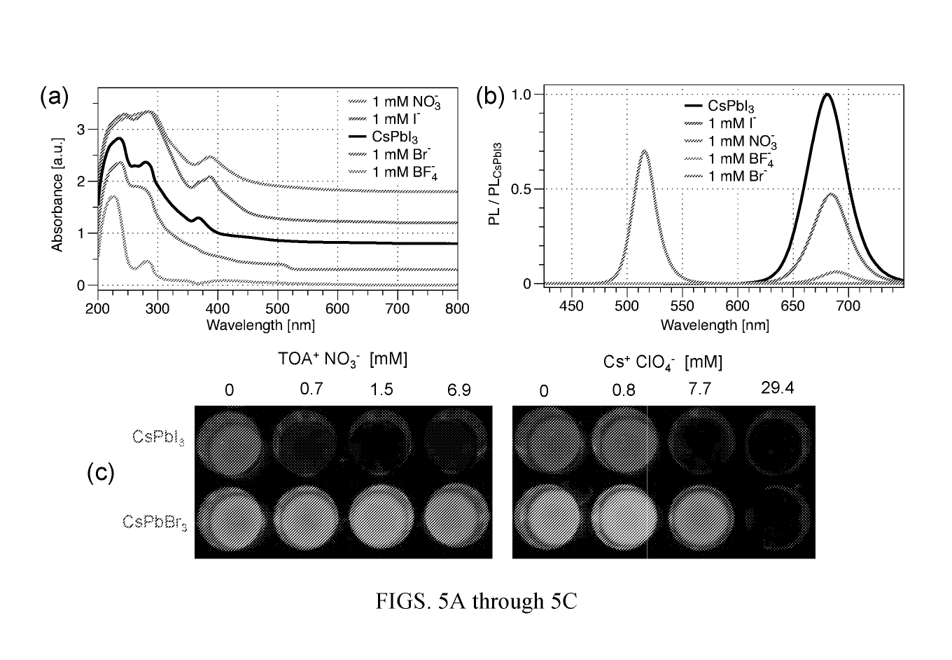

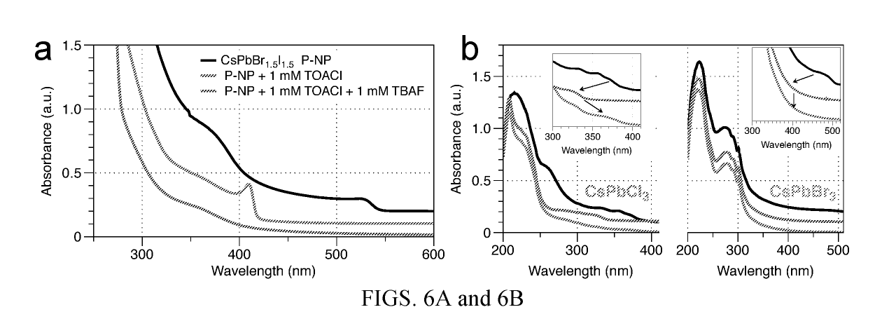

Both Br⁻ and Cl⁻ will substitute in CsPbI₃, but the resulting CsPbCl₃ were not observed to convert upon treatment with I⁻, in agreement with FIG. 1b. However, using this exchange approach, a large assortment of XYZ₃ NPs can be prepared depending on which anion (or cation) needs to be monitored or detected (FIG. 3). For example, CsPbZ₃ NPs was reacted with Br, I⁻, NO₃_{^{−}}, and BF₄_{^{−}}, and then monitored in the UV-vis and PL spectra to observe potential anion exchange as shown in FIGS. 5a and 5b, respectively. It is clear that both NO₃_{^{−}} and BF₄_{^{−}}produce strong changes in the spectral properties of the NP suggesting the formation of CsPb(NO₃)₃ and CsPb(BF₄)₃. Interestingly, an increase in absorbance was observed at ˜380 nm in the NO₃-substitution reaction, which is likely due to direct oxidation of I⁻ to I₂ or I₃⁻. This shows additional utility of the approach, where relative oxidative strengths of constituents in organic media can be sorted and evaluated. FIG. 5C shows that an assay consisting of red emitting CsPbI₃ and green emitting CsPbBr₃ NPs can be quenched due to the electrochemical potential of the oxidant and relevant oxidant concentration. FIG. 6 suggests that F⁻ also can potentially be exchanged as well. Taken together, these results indicate that the XYZ₃ NPs can be readily exchanged both by halides as well as other anions. This exchange causes a color change which can be observed by eye using a UV-lamp to light the solution and induce fluorescence, or by an absorbance or fluorescence spectrometer.

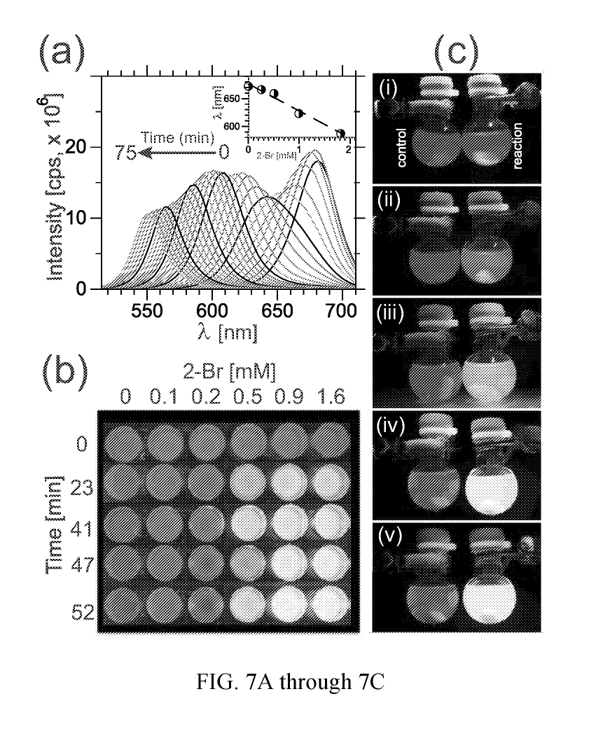

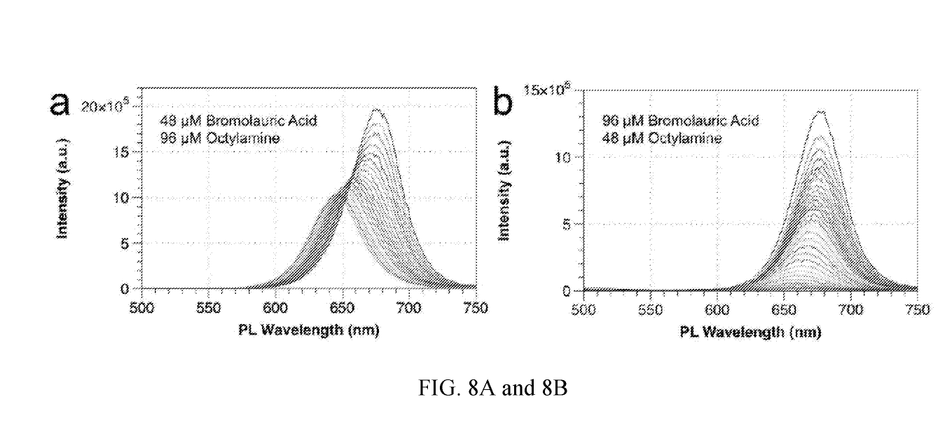

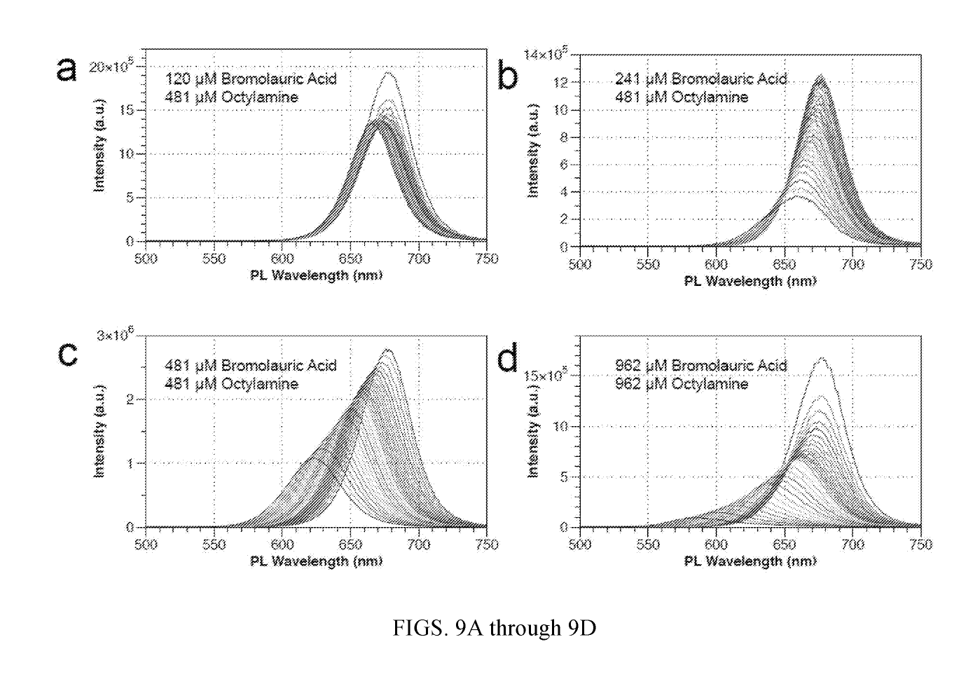

As shown above, the XYZ₃ NPs are highly sensitive to anion concentration and type, and may be great candidates for development of a simple assay. To test this, the XYZ₃ NPs were combined with 2-bromododecanoic acid and octylamine and the change in emission wavelength (eg. color) indicated a reaction. FIG. 7a shows the reaction monitoring in real-time, where a solution of 2-bromododecanoic acid (481 μM) was dissolved in hexanes with equal parts octylamine. The solution contained approximately ˜15 μg of CsPbI₃ NPs. The spectrophotometric monitoring of the formation of products follows the PL change as a consequence of the conversion of CsPbI₃ to CsPbBr₃, due to the increased concentration of Br⁻ leaving groups. The inset of 7a shows that the rate of Br⁻ release, and thereby reaction rate, is strongly dependent on the amount of 2-Br in solution. The assay was easily prepared in well-plate form to provide a combinatorial assay as shown in FIG. 7b to serve as a bench top assay of reaction rate. As a control, consider a similar solution of dodecanoic acid, which does not have the halide component and does not undergo reaction. FIG. 7c shows the time lapsed imaging of both 2-Br and dodecanoic acid over time, showing by color change that only one substrate causes the observed reaction. Using this approach, reaction kinetics can easily be followed colorimetrically. FIGS. 8-9 shows the reaction rates of this model reaction where [CsPbI₃] was held constant but both the [2-Br] and [amine] were varied.

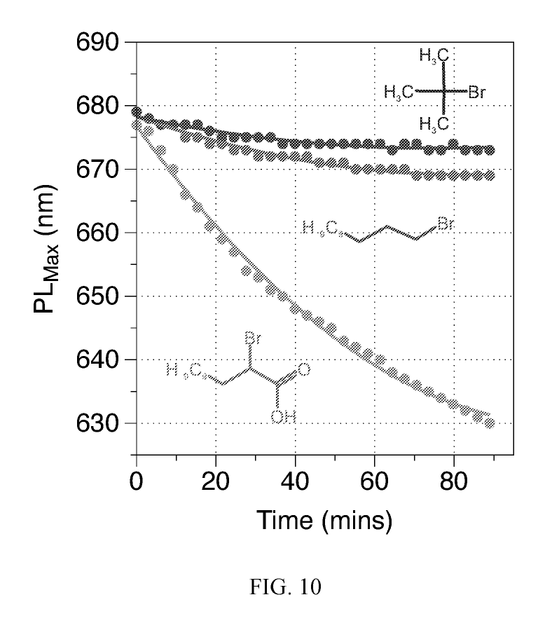

In all cases, the PL shifts are related to reaction kinetics, the solution equilibrium, and the particular reaction mechanism. The general applicability of this method is demonstrated in FIG. 10 where different organohalide substrates exhibit significantly different reaction rates, in agreement with general mechanistic considerations. These results suggest that future advances will allow precise mechanistic insights to be obtained using this method.

One additional advantage of NPs according to the present invention is a high thermal stability of the PL. At temperatures of up to 50° C., only a small drop in QY was observed, allowing for future reaction monitoring to occur at elevated temperature. While these results show only a simple reaction, the starting XYZ₃ NPs can be tuned to the reaction desired, presuming that the reaction releases a reactive anion, small molecule, chemical vapor, or exposure to radiation.

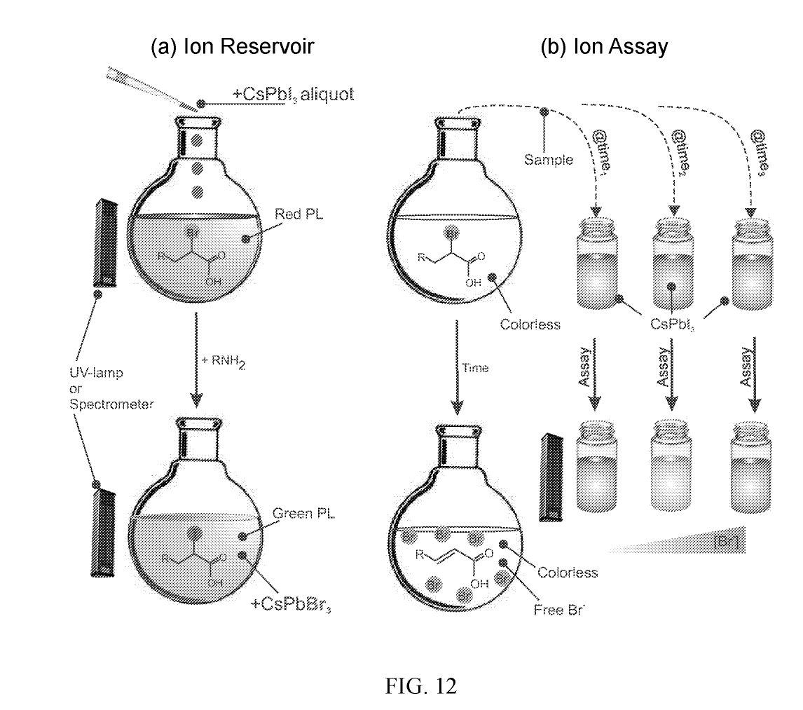

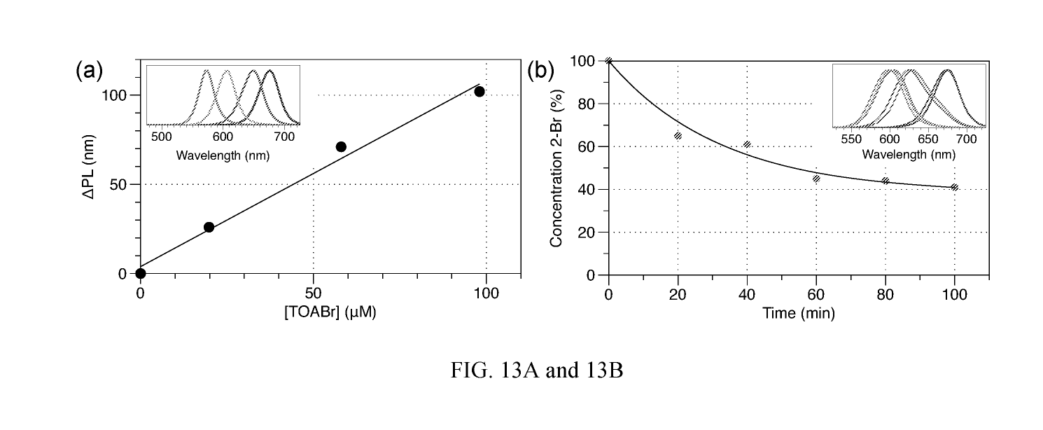

In addition to the use of XYZ₃ NPs as ion reservoirs for chemical reactions, participating in and reporting back on the transformation of organohalides in situ as shown in FIGS. 7-10, the invention also can be used to assay the kinetics of other reactions at the bench. FIG. 12 shows the general scheme whereby XYZ₃ NPs can be added in situ to affect and report on reaction kinetics (FIG. 12a) or can be used as an indicator of reaction progress without participating in the reaction itself (FIG. 12b). The present invention was tested using the reaction of 4 mM 2-bromododecanoic acid and 32 mM octylamine refluxed in toluene, with small aliquots removed and added to a solution of CsPbI₃ NPs over the course of 120 minutes. The NP photoluminescence PL shifts were calibrated against a known concentration of tetraoctylammonium bromide (FIG. 13a) and the resulting PL shifts obtained from the reaction assay were used to determine the rate and yield of the elimination reaction (FIG. 13b). The assay reported an overall yield of 50% after one hour, providing a simple, non-invasive, and low cost method for characterizing reactions at the bench top.

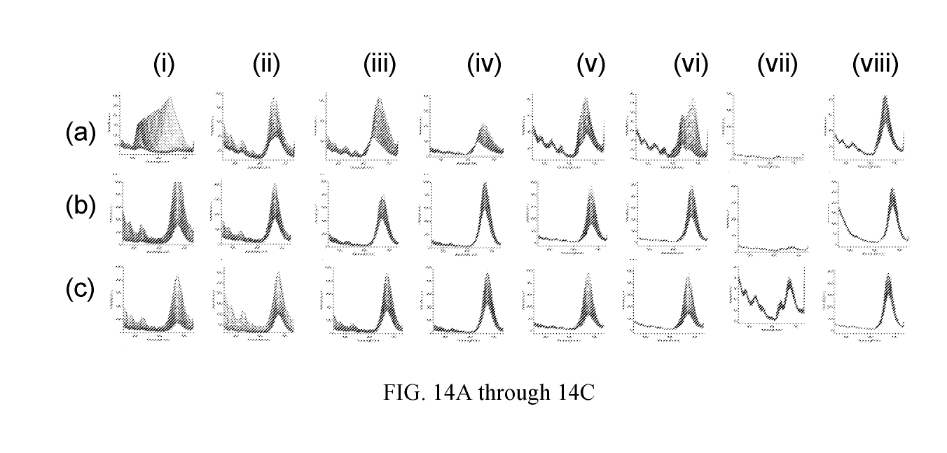

The described method also allowed for rapid characterization of combinatorial reactions using automated instrumentation. FIGS. 14A thru 14C shows the combinatorial processing of the three substrates used in FIG. 10 reacting with ˜15 μg/mL of CsPbI₃ NPs in the presence of seven different amines every 5 minutes. Shift of photoluminescence over time gives the Finkelstein exchange reaction rate between the NP and substrate, while correspondingly no shifts in wavelength indicate little reaction over the time frame of the experiment. Additionally, rapid loss of PL indicates unwanted side reactions between the CsPbI₃ NP ion reservoir and the reactants.

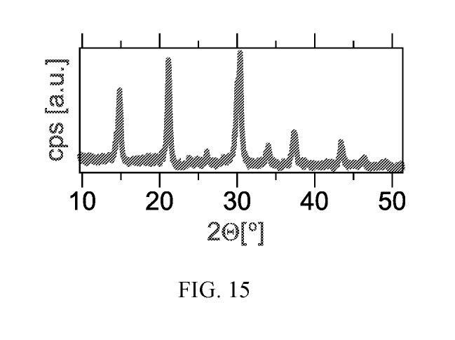

Ion sensitivity for reaction monitoring, catalysis, or sensing applications could be further manipulated through a number of factors. The underlying crystal structure of the XYZ₃ NP is crucial for photoluminescence and the method in general. FIG. 15 shows the powder XRD of CsPbBr₃ NPs revealing a cubic crystal structure. In general, XYZ₃ NPs of the composition CsPbI₃ are more prone to phase changes and loss of photoluminescence, which is useful for the development of anti-tampering and moisture sensing as described below, whereby PL loss is an assay of environmental exposure and time.

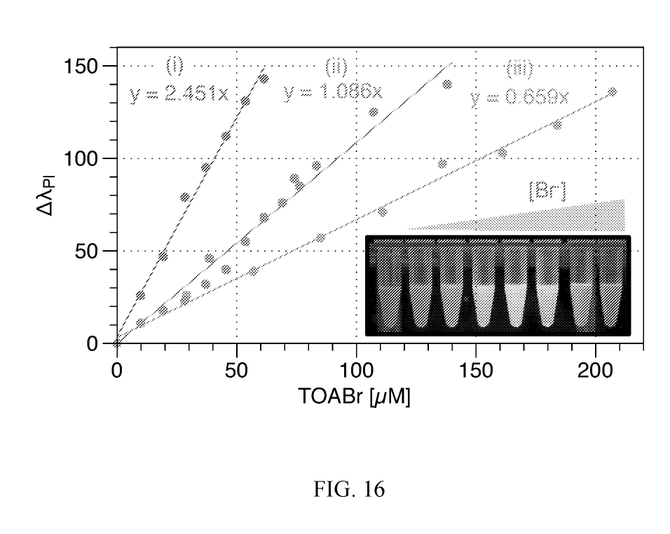

The colorimetric response of XYZ₃ NPs to free ion concentration was directly proportional to the concentration of NPs in solution, as shown in FIG. 16. Using NP concentrations of 32 μg/mL allowed for improved sensitivity (˜1 nm PL shift/400 nM Br) but with a faster saturation time, while NP concentrations of 108 μg/mL resulted in lowered sensitivity (1 nm PL shift/1500 nM Br) but a much larger dynamic range. The calibration shown in FIG. 16 allows for scaling of NP concentration to match the ion sensing regime of the desired application.

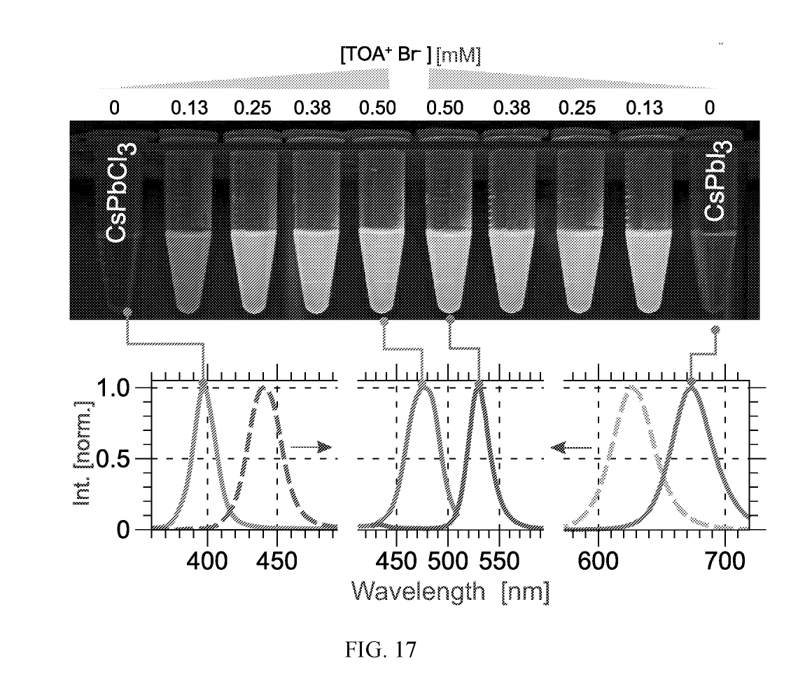

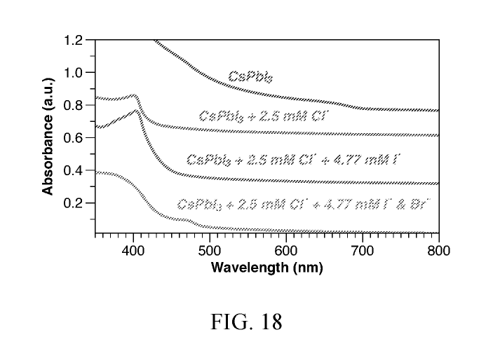

Alternatively, changing the composition of the XYZ₃ NPs also altered the ion sensitivity as shown in FIG. 17 where CsPbI₃ NPs converted to CsPbBr₃ NPs at very low Br⁻ concentrations, but CsPbCl₃ NPs were much slower to change as a function of ion concentration. The comparative equilibrium of free I⁻ and Br⁻ ions drives incorporation while the opposite trend is observed for Cl⁻ and I⁻. Additionally, the thermodynamic driving force for ion exchange in XYZ₃ NPs according to the tolerance factor (shown in FIG. 1) also dictated the selectivity of ions that were exchanged, as stated previously. FIG. 18 shows that while CsPbI₃ NPs can be readily converted to CsPbCl₃ NPs in the presence of excess (2 mM) Cl⁻, the reverse reaction does not occur when twice the amount of is added. Spectral changes are only observed when Br⁻ is first added to the solution, making the CsPbCl₃ NP insensitive to I⁻ ions in solution. It is envisioned that design principles based on the tolerance factor can improve XYZ₃ assays to be both more sensitive and selective for different analytes.

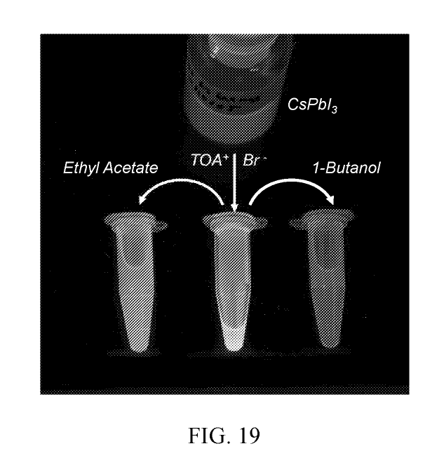

Ion sensitivity was also found to be dictated by the relative dielectric medium surrounding the XYZ₃ NPs. FIG. 19 shows the dramatic change in PL emission wavelength of as synthesized CsPbI₃ NPs upon exposure to tetraoctylammonium bromide, changing from red to yellow. Upon addition of either ethylacetate (εᵣ˜6.02) or 1-butanol (εᵣ˜17.51), the NP PL color changes to green and red, respectively, indicating that Br⁻ ions are more favored in the NP lattice in non-polar environments, while the I⁻ ions are more favored in the NP lattice in more polar environments.

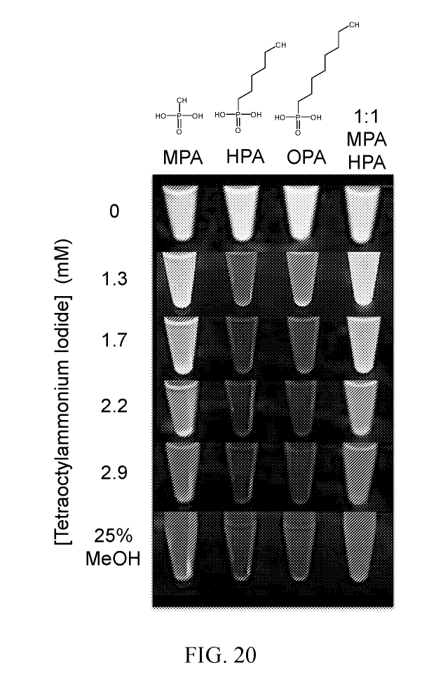

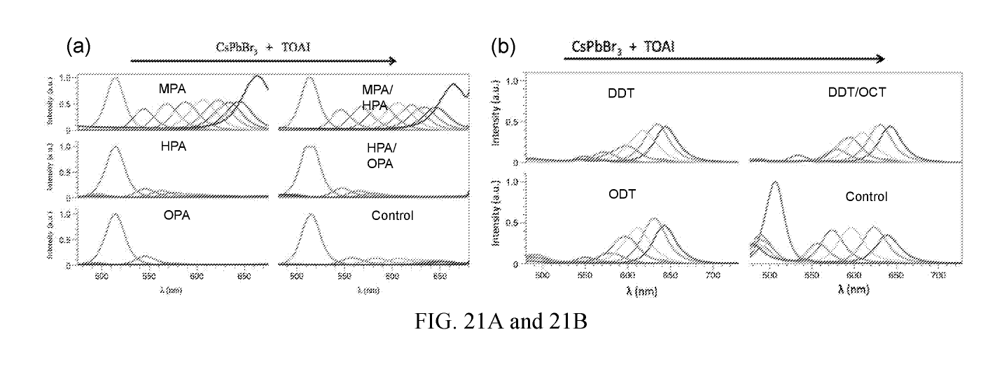

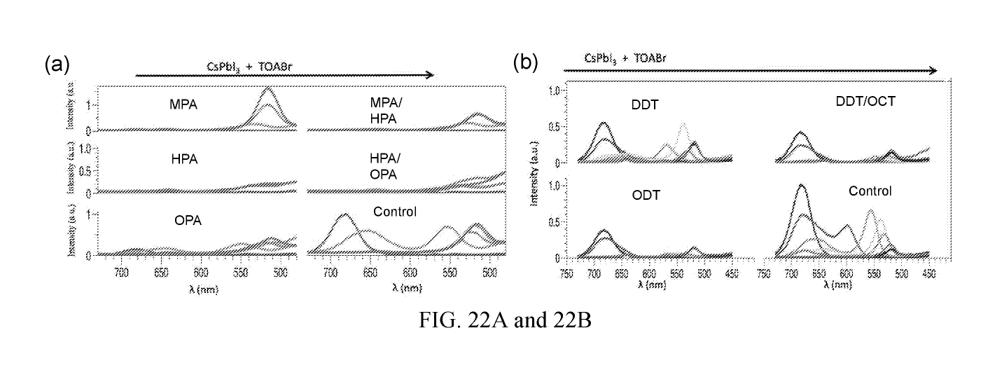

The micro-environment of the XYZ₃ NPs was further manipulated by altering the surface chemistry, which is desirable for improving both stability and ion exchange efficiency. FIG. 20 shows the ion response of CsPbBr₃ NPs to free I⁻ concentration in hexane in the presence of 2 mM methylphosphonic acid (MPA), 2 mM hexylphosphonic acid (HPA), 2 mM octylphosphonic acid (OPA), and a 1:1 mixture of MPA/HPA. From this image, it is clear that MPA stabilizes the particle during the assaying while the others show poorer stability. When the solvent environment is made more polar with methanol, which normally leads to dissolution of the ionic lattice, the NPs retain strong photoluminescence and stability. FIGS. 21 and 22 show that surface chemistry is important relative to the composition of XYZ₃ NP as well. FIG. 21 shows that CsPbBr₃ PL doesn't change with the addition of phosphonic acids (FIG. 21a), but is essentially quenched in the presence of thiols (FIG. 21b). Conversely, the PL of CsPbI₃ NPs is quenched in the presence of phosphonic acids (FIG. 22a) but is unperturbed in the presence of thiols (FIG. 22b). Importantly, after ion exchange showed photoluminescence behavior. Thus in addition to free ions, the presence of different chemical functionalities (i.e. thiols, phosphonic acids, carboxylic acids, etc.) can also be assessed using this method.

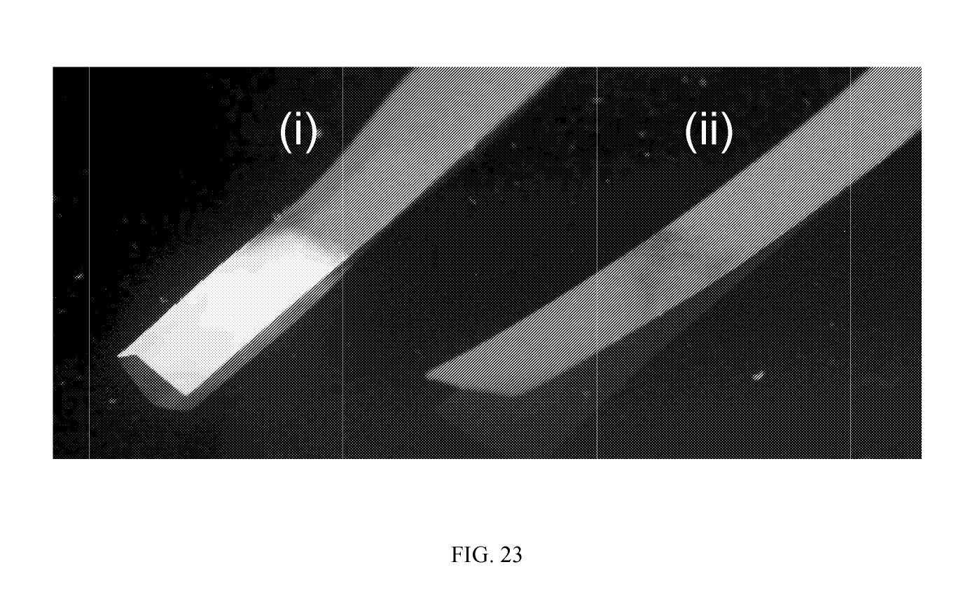

The translation of XYZ₃ NP based colorimetric assays to more traditional products was explored through the development of ion test strips, as shown in FIG. 23. The exposure of the test strip, that contained XYZ₃ NP loaded to filter paper, to a 0.1M TOABr solution caused a dramatic color change (i) relative to the as-prepared CsPbI₃ NP test strip (ii) under UV irradiation. The simplicity of this approach lends itself to inclusion in more complex environments including microfluidics, polymer matrices, or stand alone films.

In conclusion, the XYZ₃ nanoparticles can be used as a colorimetric probe for ions in solution, including those released during a chemical reaction not-occurring at the nanoparticle interface. Additionally, the XYZ₃ NPs serve as a stand alone assay for molecules with leaving groups that can substitute for both X and Z components, expanding its utility to solid state based catalysis similar to ion exchange membranes. Finally, the findings indicate that XYZ3 nanoparticles can be used as halide reservoir catalysts in chemical reactions.

### EXAMPLES

### Example 1: Synthesis of XYZ₃ NPs

The XYZ3 P-NPs used in this to demonstrate this phenomenon were first synthesized according to the report by Nedelcu and Kovalenko et al., and then exchanged with alkylammonium halides to tune wavelength. It is expected that XYZ3 NPs synthesized via alternative methods will provide similar results. For example, the XYZ₃ P-NPs are used as an intermediate in the preparation of novel nanomaterials through tetraalkylammonium salt based ion exchange, as shown in FIGS. 1 and 6. In the current invention, CsPbCl₃ NPs were used as a precursor for the synthesis of CsPbCl₃₋ₓFₓ NPs in an air free environment. Briefly, a desired amount of CsPbBr_{1.5}I_{1.5} NP in hexane was reacted with 1 mM tetraoctylammonium chloride, followed by reaction with 1 mM tetrabutyl ammonium fluoride, with sufficient equilibrium time to allow exchange. UV-Vis spectroscopy revealed a shift in the absorption spectrum from ˜525 nm to ˜410 nm to form CsPbCl₃ NPs, and finally to 375 nm to yield CsPbCl₃₋ₓFₓ NPs. Using pure CsPbCl₃ NPs, the CsPbCl₃₋ₓFₓ NPs could be enriched with Cl⁻ by adding 10 times excess of tetraoctylammonium chloride. Using CsPbBr₃ and CsPbI₃ NPs as starting compounds, titration with tetraoctylammonium salts let to additional formulations including CsPbBr₃₋ₓClₓ, CsPbBr₃₋ₓIₓ, and CsPbI₃₋ₓ(BF₄)ₓ. In the described method, both the Goldschmidt tolerance factor and electrochemical reduction potentials dictate the feasibility of a given XYZ₃ composition, and its envisioned that other compositions of XYZ₃ NPs can be prepared, including non-halide compositions.

### Example 2: The Use of NPs as Halide Reservoirs in Chemical Reactions

The P-NPs were used as catalysts for the transformation of organohalides in a Finkelstein halide-exchange reactions, as shown in FIGS. 8-10. Stock solutions of 13 mM 2-bromododecanoic acid [2-Br] and octylamine (OA) in hexane were prepared. In a typical reaction, a solution of CsPbX₃ NPs (˜15 μg/mL) in hexane was prepared to which the desired amount of amine was added first, followed by the desired amount of 2-Br. The reaction was either carried out in a sealed round bottom flask or sealed cuvette under N₂ gas, or in a open glass 96-well plate. Extent of reaction was monitored with a fluorimeter to provide real time kinetics including reaction completion. It is envisioned that XYZ₃ NPs of varying composition can be used to provide additional ion reservoirs for specific reactions.

### Example 3: Detection of Organohalides

Chemical detection using XYZ₃ P-NPs was studied for the assessment of organohalides in an unknown sample. In this invention, NPs with the composition CsPbI₃ and CsPbCl₃ were both found to be suitable for the detection of 2-bromododecanoic acid. In a typical reaction, a suitable amount of NP (32-108 μg/mL) was added to dry hexane (total volume of 0.5-1 mL) in the presence of a given concentration of 2-bromododecanoic acid, and the resulting change in photoluminescence emission wavelength was recorded over time on a fluorimeter. Gradual PL emission change is observed as anion replacement occurs between the NP and the alkylhalide according to a Finklestein reaction, allowing for quantification of the total amount of alkylhalide based on the final free anion equilibrium. Alternatively, mixing the two reactants into a small vial and emersion in a temperature bath (˜50° C.) speeds up the reaction, allowing for a rapid qualitative assessment of organohalide type and concentration based on the final emission color.

### Example 4: Determination of Organic Reaction Rates

The XYZ₃ NPs were used to probe the reaction rate and yield of an organic reaction in real time. The rate of an organic substitution reaction was determined using the XYZ₃ NP based assay, as shown in FIG. 13. Briefly, a solution of 4 mM 2-bromododecanoic acid was prepared in 10 mL of toluene and a varying amount of amine was added to achieve a desired concentration (4-32 mM). The solution was then heated to a reflux temperature (˜110° C.) to speed up the reaction. During this time, vials with 500 μL of 64 μg/mL CsPbI₃ were prepared separately from the reaction mixture. Some of the vials were used to prepare a ion concentration calibration curve through additions of 10 μL of varying concentrations of tetraoctylammonium bromide in 1-butanol (1-10 mM), allowing the solutions to reach equilibrium, and then measuring both the UV-Vis absorbance and photoluminescence change. The reaction rate was determined by removing a 15 μL aliquot of the reaction mixture and adding it to one of the pristine vials of CsPbI₃ NP, resulting in a color change that, after equilibrating, was quantified both by UV-Vis and PL spectroscopy. Correlation of wavelength change to time and proper consideration for solution transfers allowed direct determination of chemical rate. Although halides were utilized in this method, it is envisioned that other ions (including both cation exchange for X, and anion exchange for Y) can be achieved.

### Example 5: Assessment of Free Ion Concentrations in Solvents

The XYZ₃ P-NPs were used to directly assess free ion concentration in solvents. The invention provides direct assessment of the preference for ion solubility in solvents by correlating the change in emission wavelength of a NP with composition XYZ₃, as shown in FIGS. 16, 17, and 19. A known amount of CsPbCl₃ or CsPbI₃ NPs (15-64 μg/mL) were prepared in hexane and small increments (10-50 μL) of a known concentration of tetraoctylammonium bromide (1-13 mM) were added, resulting in a dramatic change in emission color under UV-irradiation. The sensitivity of the NP ion sensor is directly related to the ion equilibrium in organic solvents, favoring Br⁻ exchange for I⁻ but discouraging exchange of Br⁻ for Cl⁻ in this example. The bright emission of the NP assay allows for free ion concentration qualitatively, but also can be referenced against a calibration curve using a fluorimeter to yield analytical data. In this system, the use of tetraoctylammonium salts were employed as an ion source, but organic salts including different chain length ammonium and phosphonium salts can be used.

### Example 6: Assessment of Oxidative Strength in Solvents

The XYZ₃ P-NPs were used to determine the relative oxidative strength of constituents in unknown solutions and solvents, as shown in FIG. 5C. The oxidative strength of non-halide alkylammonium salts were prepared and diluted to 0.1M stock solutions. Spectral data was acquired using solutions of 54 μg/mL of the cleaned NPs. The oxidizer well plate experiment utilized 100 μL of a 65 μg/mL NP solution for each of the four wells of CsPbI₃ and CsPbBr₃, with the first well serving as the control. Next different amounts of alkylammonium nitrate or cesium perchlorate were added to the wells, mixed with a glass pipette, and allowed to react for ˜10 s. Samples were imaged under UV irradiation. Additional formulations of XYZ₃ NPs with varying reduction potentials (i.e. Z=F, Cl, etc. and Y=Sn, Bi, etc.) can be also used according to this method.

### Example 7: Combinatorial Reaction Monitoring Using NP Assays

The XYZ₃ P-NPs were used follow multiple reactions at the same time, as shown in FIGS. 7B and 14. A solution of NP with a nominal concentration of ˜32 μg/mL were added to a 96 well plate, and the effect of 2-bromododecanoic acid concentration (0.1-1 mM) on the rate of reaction between the NP and alkylhalide was monitored by visually assessing the changes in emission wavelength at the bench over time under UV-irradiation. Similarly, the same general procedure was used to determine the importance of substrate and amine type on the overall Finkelstein reaction rate by measuring the change in emission intensity and wavelength every 5 minutes in an automated well plate reader overnight.

### Example 8: Assaying Chemical Functionalities in Solution

The XYZ₃ P-NPs were used to determine the types of chemical functionalities present in an organic solution. In the present invention, CsPbBr₃ and CsPbI₃ NP s were found to be sensitive to the presence of phosphonic acid and thiol functionalities in hexane, as shown in FIGS. 21 and 22. Briefly, 200 μL of a 320 m/mL solution of the XYZ₃ NP was mixed with 50 μL of a 10 mM solution of either an alkylphosphonic acid or an alkylthiol to yield a final ligand concentration of 2 mM. When the XYZ₃ NP was CsPbBr₃, the emission was quenched in the presence of thiol but remained in the presence of phosphonic acids. Conversely, when the XYZ₃ NP was CsPbI₃ the emission was quenched in the presence of the phosphonic acid but not in the presence of thiol. The photoluminescence of the quenched NPs could be recovered upon titration with the appropriate tetraoctylammonium salt (from Br to I for the thiol and from I to Br for the phosphonic acid). This provides a turn-on sensor for thiols and phosphonic acids in free solution activated by ion exchange.

### Example 9: Test Strips for Ion Concentration

Color changing indicator test strips were constructed that used XYZ₃ NPs to make an ion sensitive colorimetric assay, as shown in FIG. 23. In the current method, filter paper was cut into two narrow strips and immersed in a solution of ˜320 μL CsPbI₃ NPs. The two pieces were dried, and then one of the pieces was dipped into a solution of ˜0.1M tetraoctylammonium bromide, while the other was kept dry to use as a control. The emission color of the test trip immersed in the bromide solution changed from red to green under UV-irradiation while the control maintained its red emission color. The described invention can be tuned through varying concentrations of XYZ₃ NPs as well as different formulations for deposition on the test strips according to a given application.

### Example 10: Color Indicators in Ion Exchange Resins

The XYZ₃ P-NPs were incorporated into anion exchange resins to provide a colorimetric indicator of anion exchange progress and composition. In this invention, a small amount of CsPbBr₃ NP (˜50 μg) was loaded onto a silica column simply by passing a solution of NP in hexanes through the column. The NPs do not translate through the column but do retain their emissive properties, resulting in loaded silica beads which can be used as the ion exchange resin. Subsequently exposing the column to a solution of free ions leads to ion exchange and a change in the emission wavelength, serving as a self reporter on the ion exchange process. Passing a concentrated solution of the original ion across the loaded silica column can regenerate the column with XYZ₃ NPs.

### Example 11: Single Reaction Imaging

The XYZ₃ P-NPs were used to monitor change at the single particle level. In this invention, a dilute solution of XYZ₃ NPs is chemical anchored to a substrate using chemical linkers based assembly and micro-pattering. A chemical substrate with a reactive leaving group consisting of a small ion in the product state is anchored near the particle. Alternatively, a catalyst, which converts the substrate, can also be anchored near the particle. A feed solution (either reactant or substrate) is added and the emission wavelength is monitored over time via single particle emission spectroscopy. Information related to kinetic rates and overall reaction yields can be obtained by looking at an ensemble measurement, while focus on individual NPs can reveal information about diffusion profiles and probabilities of transition state conversions. When combined with other in situ techniques (such as infrared spectroscopy, Raman spectroscopy, atomic force microscopy, etc.) detailed information on chemical states can be obtained at the single particle level.

In addition to these examples, we expect those skilled in the art to take advantage of the composition or local chemical or environmental changes induced colorimetric response of the NPs, the idea of inducing colorimetric change, and the limitless numbers of compositions possible and combinations of photoluminescence responses available, for various applications as described herein.

Chemical Kinetics: Someone skilled in the art of chemical synthesis can design a P-NP of different composition, morphology, microstructure, size, class, or surface chemistry to monitor chemical kinetics and yields of many different reactions. Following the examples herein, different NP formulations, or combinations of formulations, can be prepared to react with; ions, small molecules, radicals, functional groups, intermediates, excited states, oxidizers, reducers, solvents, or gases, which would result in a colorimetric response in both absorption and photoluminescence of the NP proportional to concentration. It is envisaged that the colorimetric response can be correlated to concentration and type of molecule studied based on the kinetic profile (eg. Colorimetric response), and that machine learning algorithms, artificial intelligence software, and other approaches can be used to match responses to reaction types. It is further envisaged that groups of NP formulations will be used in conjunction (eg., multiplexing) with some NP reporting on the reactions, while others report on environmental factors like temperature, pressure, pH or other important internal controls. Further, it is envisaged that NPs can be designed to react with, or catalyze reactions like so-called; Kumada, Negishi, Sonogashi, and Suzuki reactions, Gabriel, Schotten-Baumann, Williamson Ether, Wittig, Yamaguchi Esterfication, Friedel Crafts Alkylation and Acylation reactions, Vilsmer-Haack, Heck, Reformatsky, Sandmeyer, Wurtz, and others.

Instrumentation Design. Someone skilled in the art of instrumentation can design, construct and market an instrument based on NP colorimetric response. It is envisaged that machine learning software, artificial intelligence, and other software based algorithms can be used to report on the colorimetric response of the NPs. Such a machine could monitor absorption, photoluminescence response, combinations thereof, or electronic properties. Moreover, said instrument would take advantage of high throughout screening by way us automation that can use different NP compositions, formulations, or combinations to detect different molecules, biomolecules, ions, pollutants, gases, or ionizing radiation following the examples and applications described herein. It is further envisaged that such instrumentation may be combined with current instrumental techniques, either in line to analysis, or a complementary component. Such instruments may include but are not limited to; nuclear magnetic resonance (NMR), mass spectrometry (MS), liquid and gas chromatography (LC, GC), amongst others.

Anion Sensing. Someone skilled in the art can incorporate NPs into existing or novel devices to measure concentrations of anions, including halides. In addition to producing liquid based test kits, it is also envisaged that NPs could be embedded in paper or bounded to alumina, titania, ferrites, metals, or magnets, and used as disposable test-strips that could be read by eye or with simple illumination. Incorporation of different NPs in discrete locations on the strips would allow for simple, rapid multiplexing of multiple anion types and concentration.

Polymers. Someone skilled in the art of polymer science can use NPs to monitor polymerization reactions involving precursors with ionic or reactive leaving groups, or by measuring changes to catalysts condition. Moreover, the reactivity of the NP can be used as a catalytic source of ions.

Pollution. Someone skilled in the art of monitoring pollution can use NPs as colorimetric sensors of gas concentrations, ozone layer condition, ground water contamination, or green-house gas compliance by slight modification of the existing examples. It is envisaged that the NPs can be used as suspended liquids, thin-films coatings of transparent films, electrodes, or photodetectors, and corresponding change to; color, ionic conductivity, electrical conductivity, or composition can be correlated to concentrations of pollutants.

Monitoring and Detection of Chemical Warfare Agents. Someone skilled in the art of testing for, or monitoring of, chemical warfare agents (CWAs) can use NPs to detect them either at the time of an attack or to prove such attacks happened. Reactive nerve agents (eg. Sarin, VX, and others), vesicating or blistering agents (eg. Mustard, and others), respiratory agents (eg. Phosgene and others), cyanides (eg. Cyanide), amongst other known or created agents can induce a colorimetric or photoluminescent response in NPs when they are either used a liquid test kid, or when used as thin-films coatings of transparent films, electrodes, or photodetectors, or when embedded in composites or textiles, and corresponding change to; color, ionic conductivity, electrical conductivity, or composition can be correlated to concentrations of warfare agents. It is envisaged that small disposable and traceable; test strips, meters, or indicators can be integrated with military uniforms or machinery. It is further envisaged that remote monitoring could be possible either electronically or visually via satellite or arial drone.

Pharmaceuticals. Someone skilled in the art of synthesizing, producing, or analyzing pharmaceuticals can use NPs to detect and/or image genotoxic organohalides in pharmaceuticals or in waste streams as desired. It is envisaged that photoluminescence based colorimetric signals in the presence of these molecules and compounds could be detected at ultra-low levels (parts per billion) which is difficult to achieve using standard techniques.

Electrodes. Someone skilled in the art of crafting active and selective electrode coatings can use NPs as anion sensitive coatings which respond both electrochemically and optically to different anion concentrations in a given environment. It is envisaged that the high electrical and ionic conductivity of the NP combined with high surface area may allow improved performance and new capabilities.

Information Technology. Someone skilled in the art of advancing information technology can incorporate NPs into optical relays whereby halide equilibrium is used to store information due to composition dependent photoluminescence properties of the NPs. It is envisaged that small changes to the NP lattice composition would allow NPs to dump or replenished new information reversible by applying an electrical bias, electrical or optical stimuli, or thermal treatment, which can be used to code information via wavelength emitted.

Inks. Someone skilled in the art of producing high technology liquid inks, 3D printing filaments, and other printable inks can develop various NP compositions and formulations to produce color changing inks. It is envisaged that the NPs can be combined with polymers, fillers, or nano-coating technologies to custom design bright, and self-illuminating inks that change color in response to external stimuli, which induce microscopic changes in the ink.

Anti-Counterfeit Technology. Someone skilled in the art of anti-counterfeit technology can incorporate, embed, or print NP based inks or colloids to produce a unique optical signature, or color-change signature, unique to the particular NP formulation and combination used. It is further envisaged that testing can be done in cheap reproducible ways using hand held readers or lamps.

Tamper Proof Tapes and Seals. Someone skilled in the art of producing tamper proof tapes, seals, and other materials can embed, or print NPs in such a way that a color change would occur if tampered with. It is envisaged that the NPs can be embedded into such products that also have other components, which upon tampering with, cause the materials to mix, thus causing the composition of the NP to change, resulting in a colorimetric response to be observed. Such an approach could be combined with a number of the approaches used in the examples above.

Expiry. Someone skilled in the art of time release technology, or in the construction of expiry sensitive materials can formulate a NP to change color over the course of days, months, or years. This would lead to a time sensitive colorimetric response which may also be incorporated with examples and applications listed herein.

Ionic Liquids. Someone skilled in the art of ionic liquid technology, chemistry, and ionic liquid applications can use specific NP formulations to either react with specific ionic liquid components (cation or anion), or to detect any halides, water, or small molecule impurities within the liquid, both of which can be monitored by the colorimetric response and may incorporate components from the examples listed above or applications listed herein.

Oil Additives. Someone skilled in the art of oil use, oil consumption, oil degradation, oil recycling, or oil manufacturing can utilize specific formulations of NPs to colorimetrically respond to engine oils at different life cycles, ages, and conditions. It is envisaged that such colorimetric response could be used as an indicator of engine condition, oil condition, etc, and provide real-time feedback imperative for preventative maintenance.

Radiation. Someone skilled in the art of monitoring radiation can formulate a NP to colorimetrically respond to different doses either from intentional, or un-intentional exposure. It is envisaged that the oxidation of the NP is affected by such radiation, and that a colorimetric response would provide valuable, timely, and quantitative feedback. It is further considered that such radiation monitoring can be used in conjunction, or part of, the examples and applications listed herein.

Imaging. Someone skilled in the art of molecular imaging, bio-imaging, and medical imaging can formulate NPs to image cells, tissues, organs, etc. and report back via colorimetric response, the state of local ion concentrations and types, pH changes, molecular decay, pollutants, cancers, drugs or other targets. It is further envisaged that such NPs would need to be formulated for biocompatibility, and that the surface of the NP would need to be functionalized with polymers, monolayers, biomaterials, etc. that provide not only biostability, but also the ability allow for ions and small molecules to react with the NP surface, thus inducing colorimetric response like those described in the examples above.

Humidity. Someone skilled in the art of testing humidity, water content, or water impurity can formulate NPs to react with water, which may produce a colorimetric response, or a quenching of photoluminescence. It is further envisaged that such a formulation could be combined with a disposable test strip, ink, meter, or composite like those listed herein.

Magnetic Separation. Someone skilled in the art of magnetic separation of molecules, biomolecules, pollutants, or other material can incorporate NPs to add a colorimetric response capability to each separation colloid, bead, or nanoparticle. In it envisaged that NP formulations can be made that provides a real time feed back of type of molecule, loading, or condition of the magnetic bead. Further this would be used to increase the read out capability of the beads, allowing for additional separation to be completed, such as flow cytometry. It is envisaged that the NP could be embedded in the bead, at its surface, or attached via molecular linkers, and its colorimetric response would follow the examples and applications listed herein.

Batteries. Someone skilled in the art of battery theory, chemistry, construction, engineering, or usage can incorporate NPs to provide real-time feedback to ion concentrations, gradients, and blockage allowing for potential real-time monitoring, or visualizing of battery components. It is envisaged that NPs will be formulated to meet the demands of battery internals, and that real-time monitoring could be in the form of optical response, ionic conductivity change, or conductivity change, each of which would be a function of NP composition change, surface oxidation, or ion exchange.

Catalysis. Someone skilled in the art of heterogeneous catalysis can design a P-NP of different composition, morphology, microstructure, size, class, or surface chemistry to suit a range of catalytic applications where the high local concentration of ions in the P-NP provide new capability.

What is claimed is:

1. A nanoparticle system for colorimetric monitoring of ion concentrations in a reaction, comprising a perovskite nanoparticle of the composition XYZ₃, where X is a positively charged ion, Y is positively charged ion, and Z is a negatively charged ion.

2. The system of claim 1, wherein the XYZ₃ nanoparticle has the formula CsPbZ₃, wherein Z represents F⁻, Cl⁻, Br⁻, I⁻ or combinations thereof.

3. The system of claim 2, wherein the XYZ₃ nanoparticle is capable of undergoing a fluorescence color change.

4. The system of claim 2, wherein the XYZ₃ nanoparticle is capable of undergoing a fluorescence intensity change.

5. The system of claim 1, wherein the XYZ₃ nanoparticle is configured to detect a target selected from the group consisting of cations, anions, complex ions, and molecules.

6. A method of colorimetrically monitoring the ion concentration changes in a reaction in real-time, comprising the steps of:
adding an XYZ₃ nanoparticle at known concentrations to a solution containing either an unknown concentration of ions or a mixture of organohalides undergoing a chemical reaction; and
viewing any changes in any photoluminescence of the XYZ₃ over time.

7. The method of claim 6, wherein the step of viewing any changes comprises viewing qualitatively by eye or quantitatively by optical spectroscopy.

8. The method of claim 6, wherein the changes in any photoluminescence of XYZ₃ comprises a fluorescence color change.

9. The method of claim 6, wherein the changes in any photoluminescence of XYZ₃ comprises a fluorescence intensity change.

10. The method of claim 6, wherein the XYZ₃ nanoparticle undergoes a fluorescence change in response to detection of a target selected from the group consisting of cations, anions, complex ions, and molecules.

11. The method of claim 6, wherein the XYZ₃ nanoparticle has the formula CsPbZ₃, wherein Z comprises F⁻, Cl⁻, Br⁻, I⁻ or combinations thereof.

12. A method of performing real time colorimetric monitoring of reaction progress and kinetics, comprising the step of adding a XYZ₃ nanoparticle to a chemical reaction to be monitored.

13. The method of claim 12, wherein the XYZ₃ nanoparticle comprises an XYZ₃ nanoparticle having the formula CsPbZ₃, wherein Z represents F⁻, Cl⁻, Br⁻, I⁻ or combinations thereof.

14. The method of claim 13, wherein the step of adding the XYZ₃ nanoparticle to a chemical reaction to be monitored comprises the step of adding a sample of the chemical reaction to be monitored to a known concentration of an XYZ₃ nanoparticle.

15. The method of claim 14, further comprising the step of monitoring for any color change.

16. The method of claim 12, wherein the step of adding a XYZ₃ nanoparticle to a chemical reaction to be monitored comprises providing different XYZ₃ nanoparticles in a well plate assay.

17. The method of claim 16, wherein each of the different XYZ₃ nanoparticles undergoes a fluorescence color change.

18. The method of claim 16, wherein each of XYZ₃ nanoparticles undergoes a fluorescence intensity change.

19. The method of claim 16, wherein each of XYZ₃ nanoparticles undergoes a fluorescence change in response to detection of a target selected from the group consisting of cations, anions, complex ions, and molecules.
